(19) United States
(12) Patent Application Publication
(10) Pub. No.: US 2010/0114937 A1
(43) Pub. Date: May 6, 2010

(54) SYSTEM AND METHOD FOR CONTENT CUSTOMIZATION BASED ON USER'S PSYCHO-SPIRITUAL MAP OF PROFILE

(76) Inventors: LOUIS HAWTHORNE, Mill Valley, CA (US); Michael Renn Neal, Arvada, CO (US); D'Armond Lee Speers, Thornton, CO (US); Taryn Voget, San Francisco, CA (US); Anne Cushman, Fairfax, CA (US); Thomas Singer, San Francisco, CA (US)

Correspondence Address: Goodwin Procter LLP;Attn: Patent Administrator, 135 Commonwealth Drive, Menlo Park, CA, 94025-1105, US

(21) Appl. No.: 12/253,903

(22) Filed: Oct. 17, 2008

(51) Int. Cl. G06F 7/06; G06F 17/30

(52) U.S. Cl. 707/769; 707/E17.108

(57) ABSTRACT

A new approach is proposed that contemplates systems and methods to enable a user to explore his/her problems and/or linkages associated with them in a series of steps and presents a set of content (also known as a user experience) each comprising one or more content items to the user. A psycho-spiritual map is constructed for the user to explore, wherein each node in the map represents a problem, a sub-problem/factor/issue, and an emotion related to it. The map can be dynamically managed and expanded along a path of the user's exploration by a personal “agent” that understands the user's specific needs and interests. Based on such in-depth personal knowledge and understanding, the agent is capable of identifying, retrieving, customizing, and presenting a set of content to the user that specifically and continuously addresses his/her problem.

### RELATED APPLICATIONS

This application is related to U.S. patent application Ser. No. ______ being filed concurrently; and entitled “A system and method for content customization based on user profile,” by Louis Hawthorne et al., and is hereby incorporated herein by reference.

### BACKGROUND

With the growing volume of content available over the Internet, people are increasingly seeking answers to their questions or problems online. Due to the overwhelming amount of information that is available online, however, it is often difficult for a lay person to browse over the Web and find the content that actually addresses his/her problem. Even when the user is able to find content that is relevant to address his/her problem, such content is most likely to be of “one size fits all” type that addresses concerns of the general public while it does not target the specific needs or experiences of the user as an individual. It happens quite often that when the user raises the same problem multiple times under different circumstances, his/her emotions associated the problem have also changed over time and thus the problem needs to be addressed appropriately with specific content that suits his/her emotional feelings at the time. In addition, the user's problem may be so convoluted or deep-rooted that it cannot be addressed by one experience alone and has to be explored more in depth.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

FIG. 1 depicts an example of a system diagram to support content customization based on user profile and psycho-spiritual map (PS-Map).

FIG. 2 illustrates an example of the various types of information that may be included in a user profile.

FIG. 3 depicts a flowchart of an example of a process to establish the user's profile.

FIG. 4 illustrates an example of a psycho-spiritual map.

FIG. 5 depicts a flowchart of an example of a process to construct an expandable PS-map and enable the user to explore it.

FIG. 6 illustrates an example of various types of content items and the potential elements in each of them.

FIG. 7 depicts a flowchart of an example of a process to tag, organize, and establish a content library/media/book shelf.

FIG. 8 depicts a flowchart of an example of a process to support content customization based on user profile and psycho-spiritual map.

### DETAILED DESCRIPTION OF EMBODIMENTS

The approach is illustrated by way of example and not by way of limitation in the figures of the accompanying drawings in which like references indicate similar elements. It should be noted that references to “an” or “one” or “some” embodiment(s) in this disclosure are not necessarily to the same embodiment, and such references mean at least one.

A new approach is proposed that contemplates systems and methods to enable a user to explore his/her problems and/or linkages associated with them in a series of steps and presents a set of content (also known as a user experience) each comprising one or more content items to the user. Here, each of the set of content is not only relevant to addressing the problem at the moment in time, but is also customized and tailored to the specific needs and preferences of the user based on the user's profile. A psycho-spiritual map is constructed for the user to explore, wherein each node in the map represents a problem, a sub-problem/factor/issue, and an emotion related to it. The map includes links between problems to allow the user to select additional areas for exploration and the map can be dynamically managed and expanded along a path of the user's exploration by a personal “agent” that understands the user's specific needs and interests by maintaining a personal profile of the user. Based on such in-depth personal knowledge and understanding, the agent is capable of identifying potential linkages between issues and problems and providing the user with a visual representation of his/her issues via the PS-map. The agent further identifies, retrieves, customizes, and presents the set of content to the user that specifically and continuously addresses his/her problem or concern as the user seeks solutions to his/her problem.

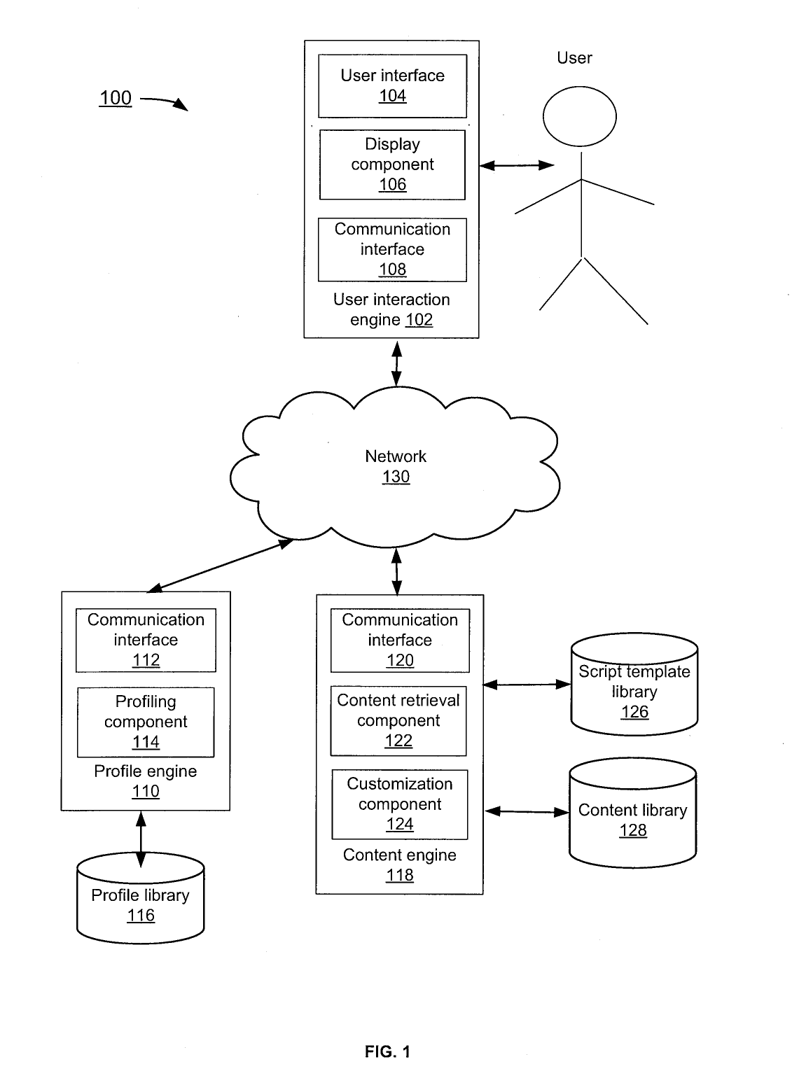

FIG. 1 depicts an example of a system diagram to support content customization based on user profile and psycho-spiritual map. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

In the example of FIG. 1, the system 100 includes a user interaction engine 102, which includes at least a user interface 104, a display component 106, and a communication interface 108; a profile engine 110, which includes at least a communication interface 112 and a profiling component 114; a profile library (database) 116 coupled to the profile engine 110; a content engine 118, which includes at least a communication interface 120, a content retrieval component 122, and a customization component 124; a script template library (database) 126 and a content library (database) 128, both coupled to the content engine 118; and a network 130.

As used herein, the term engine refers to software, firmware, hardware, or other component that is used to effectuate a purpose. The engine will typically include software instructions that are stored in non-volatile memory (also referred to as secondary memory). When the software instructions are executed, at least a subset of the software instructions is loaded into memory (also referred to as primary memory) by a processor. The processor then executes the software instructions in memory. The processor may be a shared processor, a dedicated processor, or a combination of shared or dedicated processors. A typical program will include calls to hardware components (such as I/O devices), which typically requires the execution of drivers. The drivers may or may not be considered part of the engine, but the distinction is not critical.

As used herein, the term library or database is used broadly to include any known or convenient means for storing data, whether centralized or distributed, relational or otherwise.

In the example of FIG. 1, each of the engines and libraries can run on one or more hosting devices (hosts). Here, a host can be a computing device, a communication device, a storage device, or any electronic device capable of running a software component. For non-limiting examples, a computing device can be but is not limited to, a laptop PC, a desktop PC, a tablet PC, an iPod, a PDA, or a server machine. A storage device can be but is not limited to a hard disk drive, a flash memory drive, or any portable storage device. A communication device can be but is not limited to a mobile phone.

In the example of FIG. 1, the communication interface 108, 112, and 120 are software components that enable the user interaction engine 102, the profile engine 110, and the content engine 118 to communicate with each other following certain communication protocols, such as TCP/IP protocol. The communication protocols between two devices are well known to those of skill in the art.

In the example of FIG. 1, the network 130 enables the user interaction engine 102, the profile engine 110, and the content engine 118 to communicate and interact with each other. Here, the network 130 can be a communication network based on certain communication protocols, such as TCP/IP protocol. Such network can be but is not limited to, internet, intranet, wide area network (WAN), local area network (LAN), wireless network, Bluetooth, WiFi, and mobile communication network. The physical connections of the network and the communication protocols are well known to those of skill in the art.

In the example of FIG. 1, the user interaction engine 102 is configured to enable a user to submit a problem to which the user intends to seek help or counseling via the user interface 104 and to present to the user a script of content relevant to addressing the problem submitted by the user via the display component 106. Here, the problem (or question, interest, issue, event, condition, or concern, hereinafter referred to a problem) of the user provides the context for the content that is to be presented to him/her. The problem can be related to one or more of personal, emotional, spiritual, relational, physical, practical, or any other need of the user. In some embodiments, the user interface 104 can be a Web-based browser, which allows the user to access the system 100 remotely via the network 130.

In some embodiments, the user interaction engine 102 presents a pre-determined list of problems that could possibly be raised by the user in the form of a list, such as a pull down menu, and the user may submit his/her problem by simply picking and choosing a problem in the menu. The menu can be organized by various categories or topics in more than one level. By organizing and standardizing the potential problems from the user, the menu not only saves the user's time and effort in submitting the problems, but also makes it easier to identify relevant script templates and/or content of the problem submitted.

In some embodiments, the user interaction engine 102 is configured to enable the user to provide feedback to the content presented to him/her via the user interface 104. Here, such feedback can be, for non-limiting examples, ratings or ranking of the content, indication of preference as whether the user would like to see the same or similar content in the same category in the future, or any written comments or suggestions on the content that eventually drive the customization of the content. For non-limiting examples, a rating can be from 0-10 where 0 is worst and 10 is best, or 5 stars. There can also be a comment by a user that he/she does not want to see poetry.

In the example of FIG. 1, the profile engine 110 manages a profile of the user maintained in the profile library 116 via the profiling component 114 for the purpose of generating and customizing the content to be presented to the user. The user profile may contain at least the following areas of user information:

Administrative information includes account information such as name, region, email address, and payment options of the user.

Static profile contains information of the user that does not change over time, such as the user's gender and date of birth to calculate his/her age and for potential astrological consideration.

Dynamic profile contains information of the user that may change over time, such as parental status, marital status, relationship status, as well as current interests, hobbies, habits, and concerns of the user.

Psycho-Spiritual Dimension describes the psychological, spiritual, and religious component of the user, such as the user's belief system (a religious, philosophical or intellectual tradition, e.g., Christian, Buddhist, Jewish, atheist, non-religious), degree of adherence (e.g., committed/devout, practicing, casual, no longer practicing, “openness” to alternatives) and influences (e.g., none, many, parents, mother, father, other relative, friend, spouse, spiritual leader/religious leader, self).

Community Profile contains information defining how the user interacts with the online community of experts and professionals (e.g., which of the experts he/she prefers or blocks in the community and which problems to which the user is willing to receive request for wisdom (RFW) and to provide his/her own input on the matter).

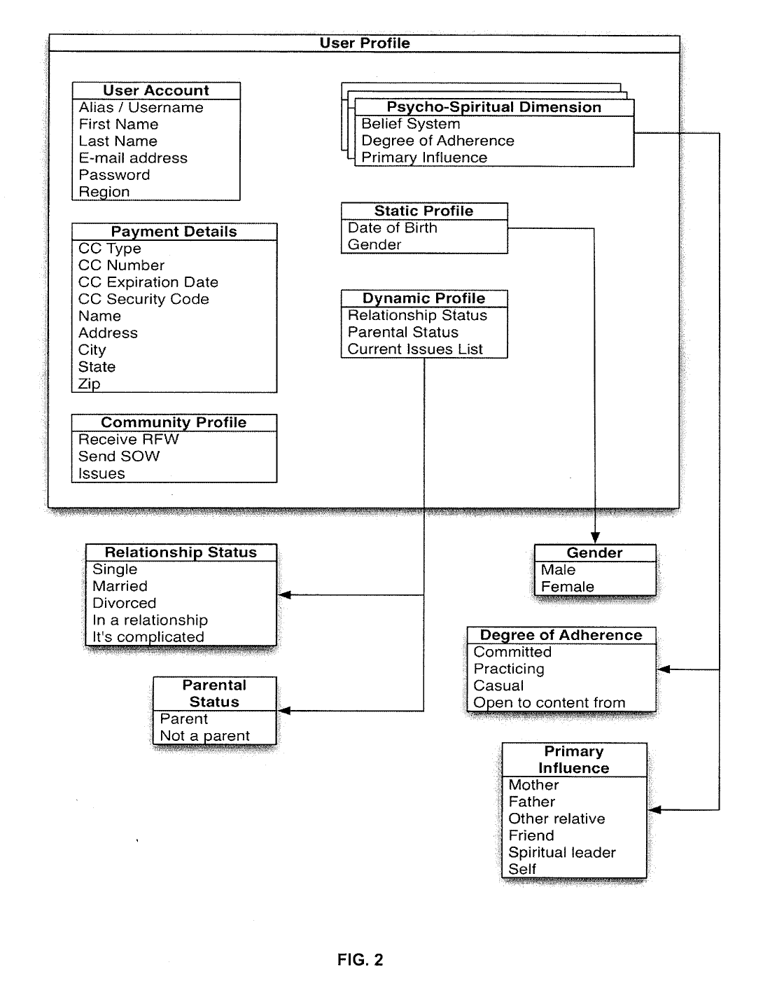

FIG. 2 illustrates an example of the various types of information that may be included in a user profile.

In some embodiments, the profile engine 110 initiates one or more questions to the user via the user interaction engine 102 for the purpose of soliciting and gathering at least part of the information listed above to establish the profile of the user. Here, such questions focus on the aspects of the user's life that are not available through other means. The questions initiated by the profile engine 110 may focus on the personal interests or the spiritual dimensions as well as dynamic and community profiles of the user. For a non-limiting example, the questions may focus on the user's personal interest, which may not be truly obtained by simply observing the user's purchasing habits.

In some embodiments, the profile engine updates the profile of the user via the profiling component 114 based on the prior history/record and dates of one or more of:

problems that have been raised by the user;

relevant content that has been presented to the user;

script templates that have been used to generate and present the content to the user;

feedback from the user to the content that has been presented to the user.

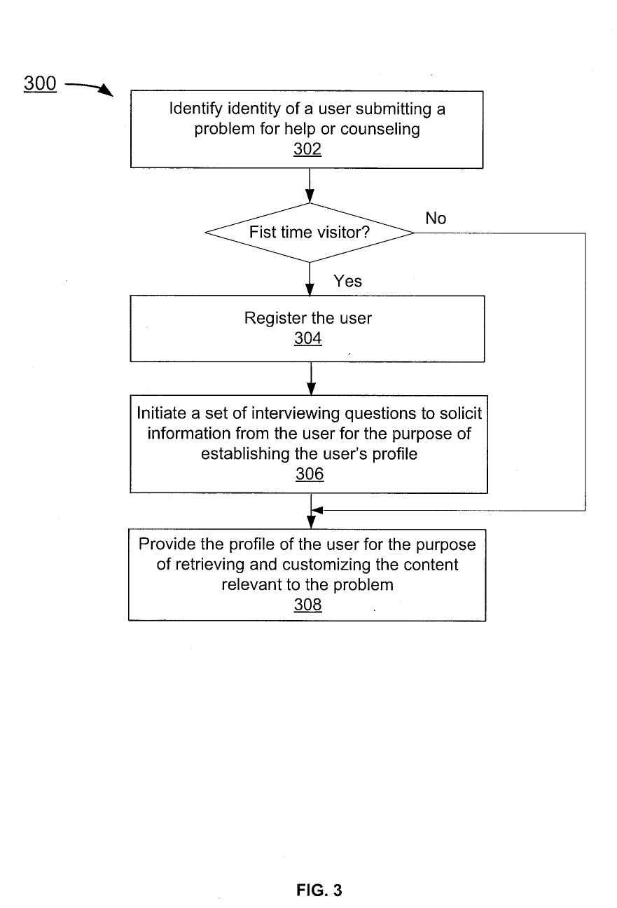

FIG. 3 depicts a flowchart of an example of a process to establish the user's profile. Although this figure depicts functional steps in a particular order for purposes of illustration, the process is not limited to any particular order or arrangement of steps. One skilled in the relevant art will appreciate that the various steps portrayed in this figure could be omitted, rearranged, combined and/or adapted in various ways.

In the example of FIG. 3, the flowchart 300 starts at block 302 where the identity of the user submitting a problem for help or counseling is identified. If the user is a first time visitor, the flowchart 300 continues to block 304 where the user is registered, and the flowchart 300 continues to block 306 where a set of interview questions are initiated to solicit information from the user for the purpose of establishing the user's profile. The flowchart 300 ends at block 308 where the profile of the user is provided to the content engine 118 for the purpose of retrieving and customizing the content relevant to the problem.

In the example of FIG. 1, the profile engine 110 establishes and maintains in the profile library 116 a so-called psycho-spiritual map (referred to as PS-Map hereinafter) of the user together with the profile of the user. Here, each node in the PS-Map represents a problem or a sub-problem (or factor or cause or issue, all referred to as sub-problems hereinafter) and/or their associated emotions that can be derived from the problem submitted by the user. Here, each sub-problem refers to a possible cause, reason, or triggering event that may relate to, cause or contribute to the problem. Each edge in the PS-Map connects two related nodes together and enables the user to explore from one to another. Content that has been generated based on the user's selection of a certain cause or emotion can be associated with the corresponding sub-problem or emotion nodes in the PS-Map via a link (while the actual content is saved in the content library 128 and managed by the content engine 118 as discussed below).

In some embodiments, the profile engine 110 may gather the sub-problems as part of the user's profile outlined above by interviewing the user about his/her background and issues he/she encountered in childhood and/or adulthood. Based on the information gathered, the profile engine 110 may identify the sub-problems, as well as the associated emotions most likely related to the user's problems, and establish the connections among them accordingly. In addition, the profile engine 110 may facilitate the construction of the PS-Map for the user by dynamically including and/or deducing from any existing node in the PS-Map a new problem node, a sub-problem node, a emotion node, and edges/connections between the nodes at any time by, for a non-limiting example, interviewing the user with new questions about his/her personal history or preferences. In essence, the profile engine 110 may choose to play a role of an online therapist, counselor, or problem solver.

In some embodiments, the user interaction engine 102 is configured to enable the user to identify sub-problems and associated emotions as well as to establish connections among the corresponding nodes in the PS-Map by him/herself. More specifically, the user interaction engine 102 enables the user to create a new sub-problem and/associated emotion node in his/her PS-Map, and to draw a connection between any pair of the problem, sub-problem, or emotion node that the user deemed as related. If the user is not sure if a certain factor has caused his/her problem, or if certain problems or emotions are related, he/she may tag relevant nodes in the PS-Map and optionally provide a query asking for further assistance or help by the profile engine 110 to create certain sub-problem or emotion nodes in the PS-Map and to establish appropriate connections among the corresponding nodes in the PS-Map.

In some embodiments, the user interaction engine 102 also enables the user to dynamically change the configuration of his/her PS-Map by adding, expanding or shrinking the map at certain nodes. If a user intends to explore one or more of the sub-problems as the possible causes of his/her problem by choosing that node, he/she may click on an expand button or image associated with the problem node. The profile engine 110 may then confirm the user's choice, and deduce and expand a set of sub-problem nodes from that problem node in the PS-Map dynamically to offer more options to explore one or more emotions associated with the sub-problem or cause and to further generate and provide customized content to address the user's problem based on this specific cause of problem the user has chosen. Likewise, the profile engine 110 enables the user to explore a set of emotion nodes expanded from a chosen sub-problem node by click of a button.

In some embodiments, the profile engine 110 may group problems from the user that fall within the same category in the same area of the user's PS-Map, as these problems often share a similar set of causes (sub-problems) and emotions. For a non-limiting example, problems related to the user's psychological and spiritual needs are often together, as these problems may often be attributed to causes or solutions in the user's spiritual awareness, such as his/her belief system. Causes that are mainly related to the user practical concerns in daily life can then be placed in areas further away from the his/her spiritual concerns in the PS-Map.

In some embodiments, the profile engine 110 may compare PS-Maps of users having similar profiles and/or sharing similar problems or concerns in order to construct a map for deeper understanding of a user's problem and to trace his/her path of progress. If user A has raised a specific problem many times and has already explored causes and emotions associated with it extensively with multiple pieces of content generated over time, his/her PS-Map can be used as an anonymous reference to build and expand a PS-Map for user B, who may have only submitted the same problem for the first time. Through such comparison, the profile engine 110 may have a better understanding of what kind of experience user B may go through in the future, and what kind of content will most likely address his/her problem along the way so that user B's problem can be dealt with more accurately and efficiently. As a result of such comparison, the profile engine 110 may copy a certain portion of the PS-Map of user A, including both nodes and edges as well as the content items associated with the nodes, over to the PS-Map for user B to serve as at least a starting point for user B, subject to further exploration and customization by user B. In some embodiments, the profile engine 110 may choose to copy only those content items that have been highly rated or positively commented,

In the example of FIG. 1, the user interaction engine 102 presents the PS-Map to the user and enables the user to explore a path through the PS-Map that reflects the potential causes of his/her problem as well as his/her emotions associated with the causes at the time. In the mean time, the profile engine 110 marks the user's “footprint” or path in his/her PS-Map by explicitly flagging any node that has been visited or explored by the user in his/her PS-Map. If the user raises the same problem caused by the same sub-problem and he/she is experiencing the same emotions as he/she did the last visit, the same content previously generated and saved may be retrieved by the content engine 118 instead of being created from scratch.

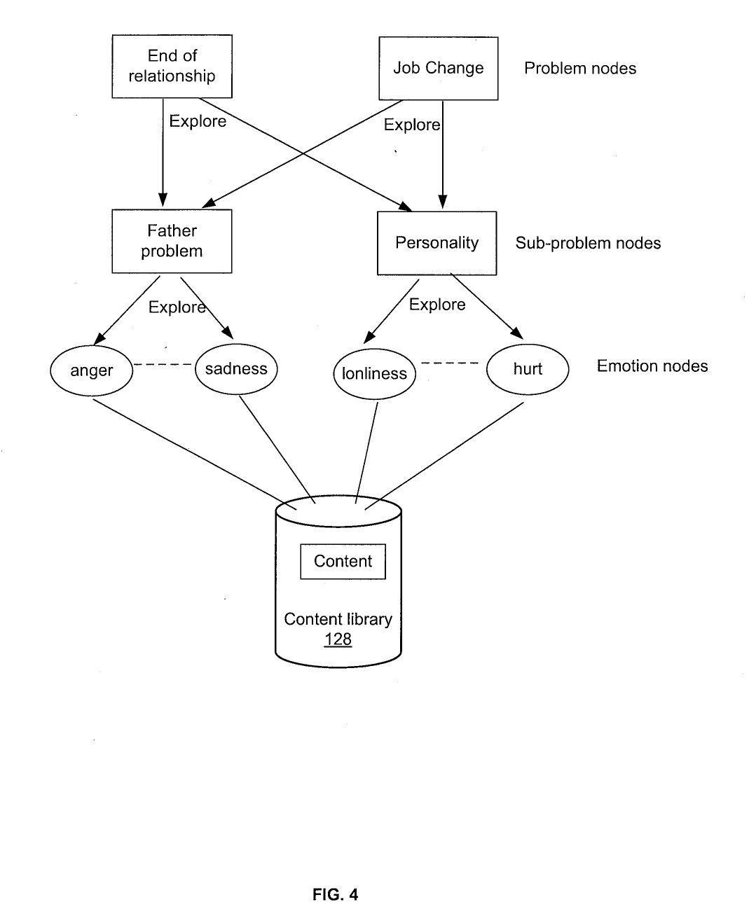

In some embodiments, the user interaction engine 102 enables the user to choose a different cause or a different emotion associated with the same cause when dealing with the same problem he/she has previously encountered. The user may explore a different path in the PS-Map from the problem node, sub-problem node, to the emotion node during each of his/her visits. For the non-limiting example of FIG. 4, although the user may still believe that his/her father problem growing up causes his/her relationship problem now, the user's feeling may have changed from anger to sadness. The profile engine 110 thus enables the user to choose a different emotion node from the last time he/she visited the PS-Map, and the content engine 118 will generate new and different content to address the user's problem based on his/her current feeling of sadness (instead of his/her prior feeling of anger) and associate such content with the emotion node representing “sadness” due to the “father” sub-problem.

For a non-limiting example, FIG. 4 illustrates an example of a PS-map, which starts with the user submitting a relationship problem on how to deal with the end of a relationship or a career problem on how to cope with an unexpected job change. Besides outside factors (such as actions of the other partner or the overall economy) that are beyond the user's knowledge or control, there may be sub-problems deep-rooted in the user's past that may have caused or contributed to the breakup or loss of job by the user. Such sub-problem can be, for a non-limiting example, growing up without the presence of a father or a personality issue. Thus, an edge may be established between the problem node “end of relationship” or “job change” with one of the sub-problem nodes “father problem” or “personality” representing the possible causes. If user intends to explore “father problem” as one of the possible causes of his/her problem by choosing that node, the profile engine 110 will provide a confirmation of connections between relationship issues and father wound by commenting “it is understood that people growing up without a father tend to have trouble sustaining relationships” and provide the user with a set of nodes of actions/readings/mediations/emotions to explore. A non-limiting example could be by asking “how do you feel about this right now?” Here, such emotions can be but are not limited to, anger, sadness, loneliness, hurt, indifference, inertness, etc. Once the user chooses any of these emotions, the choice will trigger the content engine 118 to generate content to address the user's problem in light of his/her current mental condition or psychological path.

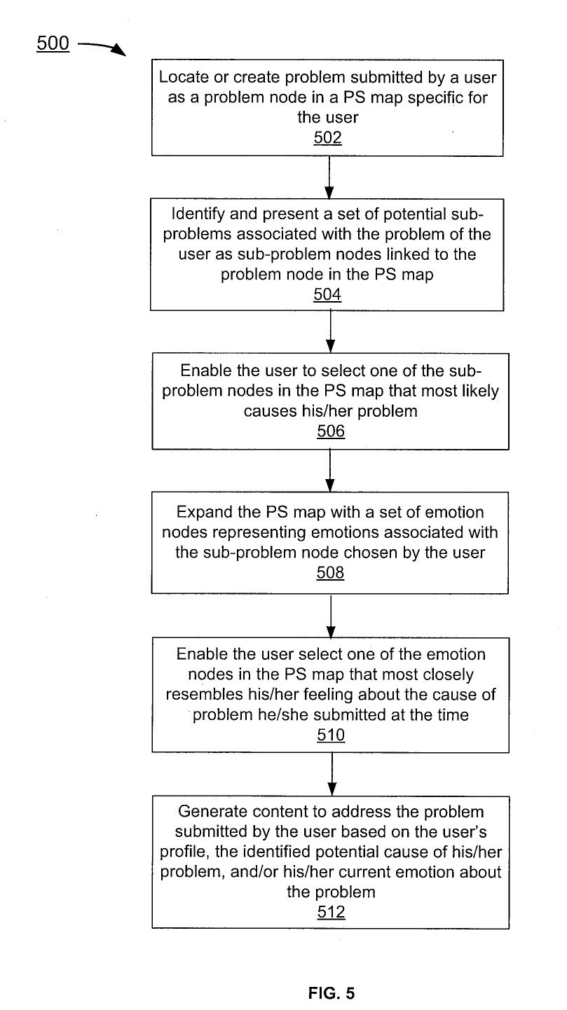

FIG. 5 depicts a flowchart of an example of a process to construct an expandable PS-map and enable the user to explore it. Although this figure depicts functional steps in a particular order for purposes of illustration, the process is not limited to any particular order or arrangement of steps. One skilled in the relevant art will appreciate that the various steps portrayed in this figure could be omitted, rearranged, combined and/or adapted in various ways.

In the example of FIG. 5, the flowchart 500 starts at block 502 where the problem submitted by a user is located or created as a problem node in a PS-Map specific to the user. The flowchart 500 continues to block 504 where a set of potential sub-problems associated with the problem of the user are identified and presented to the user as sub-problem or cause nodes linked to the problem node in the PS-Map. The flowchart 500 continues to block 506 where the user is enabled to select one of the sub-problem nodes in the PS-Map that most likely causes his/her problem. The flowchart 500 continues to block 508 where the PS-Map is expanded with a set of emotion nodes representing emotions associated with the sub-problem node chosen by the user. The flowchart 500 continues to block 510 where the user is enabled to select one of the emotion nodes in the PS-Map that most closely resembles his/her feeling about the cause of problem he/she submitted at the time. The flowchart 500 ends at block 512 where content is generated to address the problem submitted by the user based on the user's profile, the identified potential cause of his/her problem, and/or his/her current emotion about it along a path in the PS-Map from the corresponding problem node, sub-problem node, to the emotion node.

In the example of FIG. 1, the content engine 118 identifies and retrieves the content relevant to the problem submitted by the user via the content retrieval component 122 and customizes the content based on the profile and the PS-Map of the user via the customization component 124 in order to present to the user a unique experience. The content collection herein can include one or more content items, each of which can be individually identified, retrieved, composed, and presented by the content engine 118 to the user online as part of the user's multimedia experience (MME). Here, each content item can be but is not limited to, a media type of a (displayed or spoken) text (for a non-limiting example, an article, a quote, a personal story, or a book passage), a (still or moving) image, a video clip, an audio clip (for a non-limiting example, a piece of music or sounds from nature), and other types of content items from which a user can learn information or be emotionally impacted. Here, each content item can either be provided by another party or created or uploaded by the user him/herself.

In some embodiments, each of a text, image, video, and audio item can include one or more elements of: title, author (name, unknown, or anonymous), body (the actual item), source, type, and location. For a non-limiting example, a text item can include a source element of one of literary, personal experience, psychology, self help, and religious, and a type element of one of essay, passage, personal story, poem, quote, sermon, speech, and summary. For another non-limiting example, a video, an audio, and an image item can all include a location element that points to the location (e.g., file path or URL) or access method of the video, audio, or image item. In addition, an audio item may also include elements on album, genre, or track number of the audio item as well as its audio type (music or spoken word).

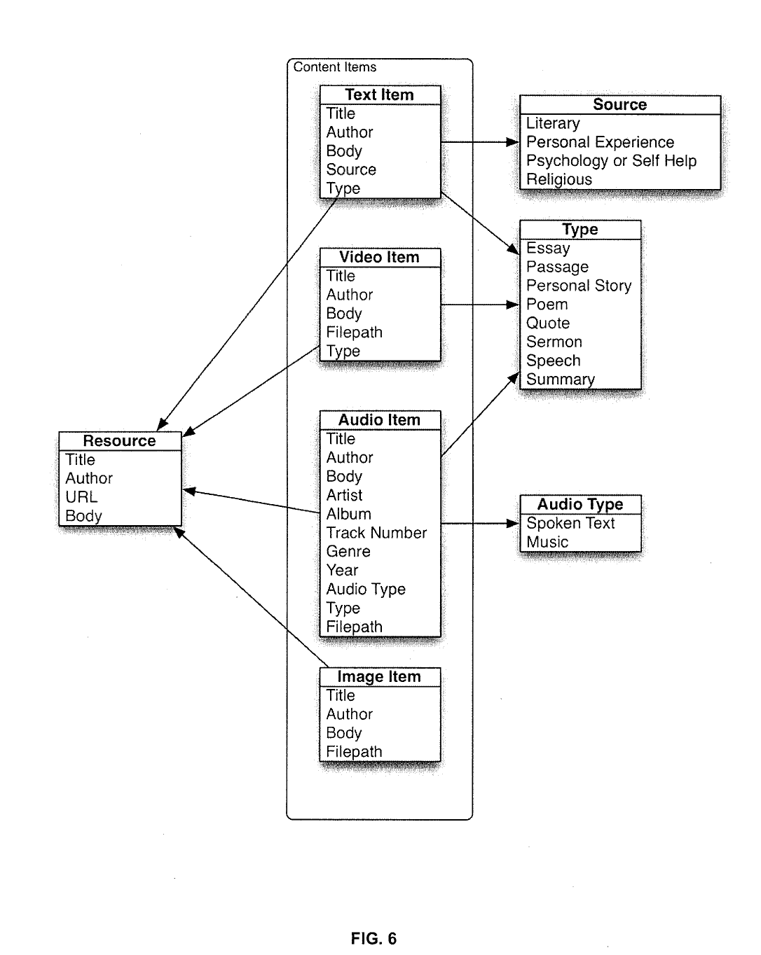

In some embodiments, the content engine 118 can associate each of a text, image, video, and audio item that is purchasable with a link to a resource of the item where such content item can be purchased from an affiliated vendor of the item, such as Amazon Associates, iTunes, etc. The user interaction engine 102 can then present the link together with the corresponding item in the content to the user and enable the user to purchase a content item of his/her interest by clicking the link associated with the content item. FIG. 6 illustrates an example of various types of content items and the potential elements in each of them.

In some embodiments, the content engine 118 may customize the content based on the user's profile including one or more of: the user's prior visits, his/her recent comments and ratings on content related to the same or relevant problems, and his/her response to request for wisdom. For a non-limiting example, content items that do not appeal to the user in the past based on his/her feedback will likely be excluded. In some situations when the user is not sure what he/she is looking for, the user may simply choose “Get me through the day” from the problem list and the content engine 118 will automatically retrieve and present content to the user based on the user's profile. When the user is a first time visitor or his/her profile is otherwise thin, the content engine 118 may automatically identify and retrieve content items relevant to the problem.

In some embodiments, the content engine 118 may customize the content based on an “experience path” of the user in his/her PS-Map. Here, the user experience path contains a list of path nodes in the PS-Map from the problem node representing the problem submitted, the sub-problem node representing the potential cause of the problem, and the emotion node representing the emotions of the user at the time. By associating the user experience path and path nodes with a content item, the content engine 118 can select appropriate content items for the user that are appropriate to his/her current experience level and mental state.

In some embodiments, the content engine 118 may identify and retrieve the content in response to the problem raised by the user by identifying a script template for the problem submitted by the user, populating the script template based on the profile of the user, and generating a script of the content by retrieving the content based on the script template. Here, a script template defines a sequence of media types with timing information for the corresponding content items to be composed as part of the multi-media content. For each type of content item in the content, the script template may specify whether the content item is repeatable or non-repeatable, how many times it should be repeated (if repeatable) as part of the script, or what the delay should be between repeats. For repeatable content items, more recently viewed content Items should have a lower chance of selection than less recently viewed (or never viewed) content items.

In the example of FIG. 1, the profile library 116 embedded in a computer readable medium, which in operation, maintains a set of user profiles of the users as well as the PS-Map of the user. Once the content has been generated and presented to a user, the profile of the user stored in the profile library 116 can be updated to include the problem submitted by the user as well as the content presented to him/her as part of the user history. If the user optionally provides feedback on the content, the profile of the user can also be updated to include the user's feedback on the content.

In the example of FIG. 1, the script template library 126 maintains a set of script templates corresponding to the pre-defined problems that are available to the user, while the content library 128 maintains content items as well as definitions, tags, and resources of the content relevant to the user-submitted problems. The content library 128 covers both the definition of content items and how the content tags are applied. It may serve as a media “book shelf” that includes a collection of content items relevant and customized based on each user's profile, experiences, and preferences. The content engine 118 may retrieve content items either from the content library 128 or, in case content items are not available there, identify content items over the Web and save them in the content library 128 so that these content items will be readily available for future use.

In some embodiments, the content items in the content library 128 can be tagged and organized appropriately to enable the content engine 118 to access and browse the content library 128. Here, the content engine 118 may browse the content items by problems, types of content items, dates collected, and by certain categories such as belief systems to build the content based on the user's profile and/or understanding of the items' “connections” with the problem submitted by the user. For a non-limiting example, a sample music clip might be selected to be included in the content because it was encoded for a user with issue of sadness.

In some embodiments, the content engine 118 may allow the user to add self-created content items (such as his/her personal stories, self-composed or edited images, audios, or video clips) into the content library 128 and make them available either for his/her own use only or more widely available to other users who may share the same problem with the user.

In some embodiments, each content item in the content library 128 can be associated with multiple tags for the purpose of easy identification, retrieval, and customization by the content engine 118 based on the user's profile. For a non-limiting example, a content item can be tagged as generic (default value assigned) or humorous (which should be used only when humor is appropriate). For another non-limiting example, a pair of (belief system, degree of adherence range) can be used to tag a content item as either appropriate for all Christians (Christian, 0-10) or only for devout Christians (Christian, 8-10). Thus, the content engine 118 will only retrieve a content item for the user where the tag of the content item matches the user's profile.

In some embodiments, the content engine 118 incorporates wisdom from a community of users and experts into the customized content. Here, the wisdom can simply be content items such as expert opinions and advice that have been supplied in response to a request for wisdom (RFW) issued by the user. The content items are treated just like any other content items once they are reviewed and rated/commented by the user.

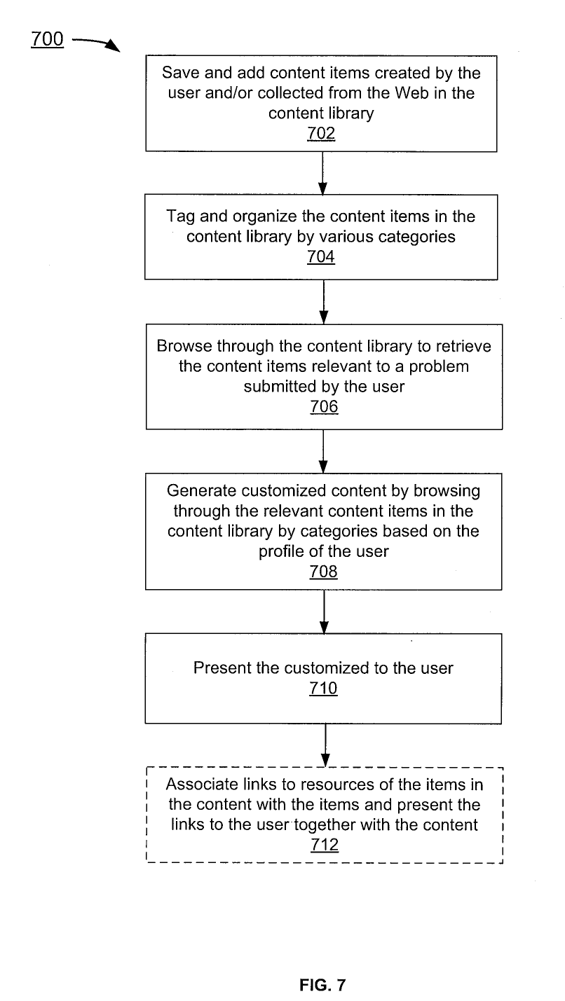

FIG. 7 depicts a flowchart of an example of a process to tag, organize, and establish a content library/book shelf. Although this figure depicts functional steps in a particular order for purposes of illustration, the process is not limited to any particular order or arrangement of steps. One skilled in the relevant art will appreciate that the various steps portrayed in this figure could be omitted, rearranged, combined and/or adapted in various ways.

In the example of FIG. 7, the flowchart 700 starts at block 702 where content items created by the user and/or collected by the content engine 118 from the Web are saved and added to the content library 128. The flowchart 700 continues to block 704 where content items in the content library 128 are tagged and organized by various categories. The flowchart 700 continues to block 706 where the content engine 118 is able to browse through the content library 128 to retrieve the content items relevant to a problem submitted by the user. The flowchart 700 continues to block 708 where the content engine 118 is further able to generate customized content by browsing through the relevant content items in the content library 128 by categories based on the profile of the user. The flowchart 700 continues to block 710 where the customized content is presented to the user. Optionally, the flowchart 700 continues to block 712 where the links to resources of the items in the content are associated with the items and presented to the user.

While the system 100 depicted in FIG. 1 is in operation, the user interaction engine 102 enables the user to login and submit a problem of his/her concern via the user interface 104. The user interaction engine 102 communicates the identity of the user together with the problem raised by the user to the profile engine 110. If the user is visiting for the first time, the profile engine 110 may interview the user with a set of questions in order to establish a profile of the user that accurately reflects the user's interests or concerns. Upon receiving the problem and the identity of the user, the profile engine 118 retrieves the profile of the user as well as a psycho-spiritual map of the user from the profile library 116, and enables the user to explore the potential causes of his/her problem as well as his/her current emotions associated with the cause in the PS-Map. The content engine 118 then identifies and retrieves content items based on the script template of the problem from the script template library 126 via the content retrieval component 122 and customizes the script template based on the user's profile as well as the user's experience path in his/her PS-Map, including the potential cause of the problem and his/her emotions associated with it, to create a script of the content that address the user's problem via the customization component 124. Once the content is generated, the user interaction engine 102 presents it to the user via the display component 106 and enables the user to rate or provide feedback to the content presented. The profile engine 110 may then update the user's profile and PS-Map with the history of the problems raised by the user, the content items presented to the user, and the feedback and ratings from the user of the content.

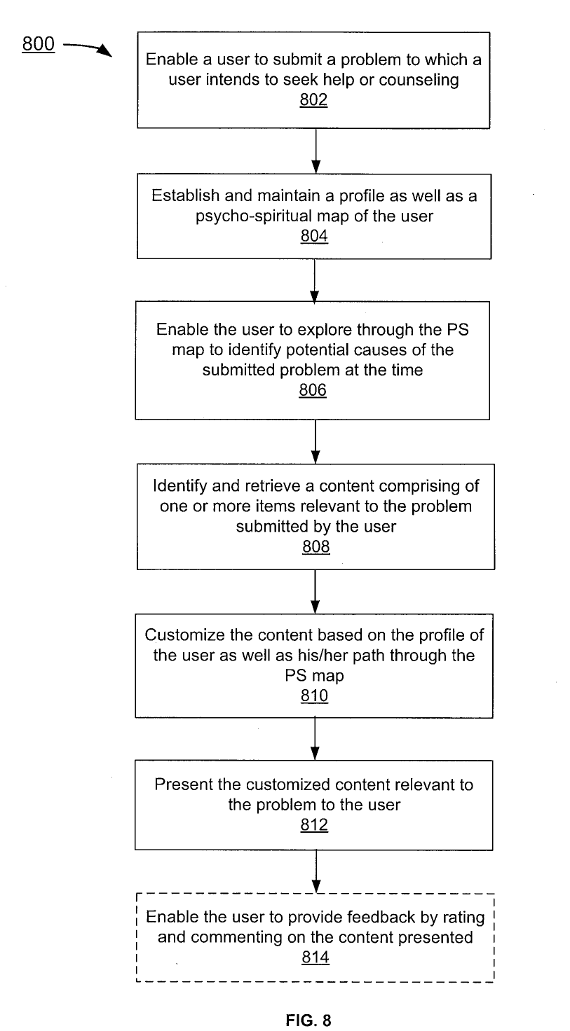

FIG. 8 depicts a flowchart of an example of a process to support content customization based on user profile and psycho-spiritual map. Although this figure depicts functional steps in a particular order for purposes of illustration, the process is not limited to any particular order or arrangement of steps. One skilled in the relevant art will appreciate that the various steps portrayed in this figure could be omitted, rearranged, combined and/or adapted in various ways.

In the example of FIG. 8, the flowchart 800 starts at block 802 where a user is enabled to submit a problem to which the user intends to seek help or counseling. The problem submission process can be done via a user interface and be standardized via a list of pre-defined problems organized by topics and categories.

In the example of FIG. 8, the flowchart 800 continues block 804 where a profile as well as a psycho-spiritual map of the user are established and maintained. At least a portion of the profile and the PS-Map can be established by initiating interview questions to the user targeted at soliciting information on his/her personal interests and/or concerns. In addition, the profile and the PS-Map of the user can be continuously updated with the problems raised by the user and the scripts of content presented to him/her.

In the example of FIG. 8, the flowchart 800 continues block 806 where the user is enabled to explore through the PS-Map to identify potential causes of the submitted problem and his/her emotions associated with it at the time. The PS-Map allows the user to take different paths during repeated visits to address the same problem so that path of the user's experience truly reflects his/her current knowledge, experience, and mental state associated with the problem.

In the example of FIG. 8, the flowchart 800 continues to block 808 where content comprising of one or more content items that is relevant to the problem submitted by the user is identified and retrieved. Here, the content can be automatically identified and retrieved based on a script template associated with the problem submitted by the user and a script of the content can be formed by “filling” the script template with the content retrieved.

In the example of FIG. 8, the flowchart 800 continues block 810 where the retrieved content is customized based on the profile of the user as well as his/her PS-Map. Such customization reflects the user's preference as to what kind of content items he/she would like to be included in the content, how each of the items in the content is preferred to be presented to him/her, the likely cause of his/her problem, as well as his/her current mental state.

In the example of FIG. 8, the flowchart 800 ends at block 812 where the customized content relevant to the problem is presented to the user. Optionally, the user may also be presented with links to resources from which items in the presented content can be purchased. The presented content items may also be saved for future references.

In the example of FIG. 8, the flowchart 800 may optionally continue to block 814 where the user is enabled to provide feedback by rating and commenting on the content presented. Such feedback will then be used to update the profile of the user in order to make future content customization more accurate.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

One embodiment includes a computer program product which is a machine readable medium (media) having instructions stored thereon/in which can be used to program one or more hosts to perform any of the features presented herein. The machine readable medium can include, but is not limited to, one or more types of disks including floppy disks, optical discs, DVD, CD-ROMs, micro drive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data. Stored on any one of the computer readable medium (media), the present invention includes software for controlling both the hardware of the general purpose/specialized computer or microprocessor, and for enabling the computer or microprocessor to interact with a human viewer or other mechanism utilizing the results of the present invention. Such software may include, but is not limited to, device drivers, operating systems, execution environments/containers, and applications.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Particularly, while the concept “interface” is used in the embodiments of the systems and methods described above, it will be evident that such concept can be interchangeably used with equivalent software concepts such as, class, method, type, module, component, bean, module, object model, process, thread, and other suitable concepts. While the concept “component” is used in the embodiments of the systems and methods described above, it will be evident that such concept can be interchangeably used with equivalent concepts such as, class, method, type, interface, module, object model, and other suitable concepts. Embodiments were chosen and described in order to best describe the principles of the invention and its practical application, thereby enabling others skilled in the relevant art to understand the claimed subject matter, the various embodiments and with various modifications that are suited to the particular use contemplated.

What is claimed is:

1. A system, comprising:
a profile engine, which in operation, establishes and maintains a profile and a psycho-spiritual map (PS-Map) of a user, wherein each node in the PS-Map represents one of: a problem submitted by the user, and a set of sub-problems that causes the problem;
a user interaction engine, which in operation,
enables the user to submit a problem to which the user intends to seek help or counseling;
presents the PS-Map to the user;
enable the user to explore a path through the PS-Map that reflects the potential causes of his/her problem;
presents to the user a content relevant to addressing the problem submitted by the user;
a content engine, which in operation, identifies, retrieves, customizes, and presents the content relevant to the problem submitted by the user based on the profile of the user and a PS-Map.

2. The system of claim 1, wherein:
the problem submitted by the user relates to one or more of: personal, emotional, spiritual, psychological, relational, physical, practical, or any other needs of the user.

3. The system of claim 1, further comprising:
a profile library embedded in a computer readable medium, which in operation, maintains the profile and the PS-Map of the user.

4. The system of claim 1, wherein:
the profile of the user includes one or more of: name, address, date of birth, gender, parental status, marital status, relationship status, belief system, psycho-spiritual dimensions, personal interests, hobbies, habits of the user.

5. The system of claim 1, wherein:
the profile of the user includes history of one or more of:
problems that have been raised by the user;
relevant content that have been presented to the user;
script templates that have been used to present the content to the user;
feedback from the user to the content that have been presented to the user.

6. The system of claim 1, wherein:
the user interaction engine is configured to enable the user to identify sub-problems as well as to establish connections among the corresponding nodes in the PS-Map by him/herself.

7. The system of claim 1, wherein:
the user interaction engine is configured to enable the user to seek help for identifying sub-problems or connections among the corresponding nodes in the PS-Map.

8. The system of claim 1, wherein:
the user interaction engine is configured to enable the user to provide feedback to the content presented.

9. The system of claim 8, wherein:
the profile engine updates the profile and the PS-Map of the user based on the problem, content, and feedback from the user.

10. The system of claim 1, wherein:
the profile engine associates the content with a corresponding node in the PS-Map.

11. The system of claim 1, wherein:
the profile engine initiates one or more questions to the user to solicit information for the purpose of establishing the profile and/or the PS-Map of the user.

12. The system of claim 1, wherein:
the profile engine creates new problem nodes and sub-problem nodes and establishes connections among them in the PS-Map.

13. The system of claim 1, wherein:
the profile engine dynamically changes configuration of the PS-Map by expanding or shrinking a set of nodes in the PS-Map at an existing node.

14. The system of claim 1, wherein:
the profile engine groups problems from the user that fall within the same category in the same area of the user's PS-Map.

15. The system of claim 1, wherein:
the profile engine compares a PS-Map of another user having similar profile or sharing similar problems or concerns as the user in order to construct the PS-Map for the user.

16. The system of claim 1, wherein:
the profile engine copies a portion of a PS-Map of another user including nodes, edges, and content items associated with them in order to construct the PS-Map for the user.

17. The system of claim 1, wherein:
the user interaction engine is configured to enable the user to select one of the sub-problem nodes in the PS-Map that most likely causes his/her problem.

18. The system of claim 1, wherein:
the user interaction engine is configured to enable the user to select one of the emotion nodes in the PS-Map that most closely resembles his/her feeling about the cause of problem at the time.

19. The system of claim 1, wherein:
the user interaction engine is configured to enable the user to choose a different cause or a different emotion associated with the same cause when dealing with the same problem he/she has previously encountered.

20. The system of claim 1, further comprising:
a script template library embedded in a computer readable medium, which in operation, maintains a set of script templates relevant to a set of problems.

21. The system of claim 20, wherein:
the content engine
identifies a script template in the script template library relevant to the problem submitted by the user;
customizes the script template based on the profile and the PS-Map of the user;
retrieves the content based on the script template.

22. The system of claim 1, wherein:
the content includes one or more items, wherein each of the one or more items is a text, an image, an audio, or a video item.

23. The system of claim 1, further comprising:
a content library embedded in a computer readable medium, which in operation, maintains content as well as definitions, tags, and source of the content relevant to user-submitted problems.

24. The system of claim 23, wherein:
the content in the content library are tagged and organized appropriately for the purpose of easy identification, retrieval, and customization.

25. The system of claim 23, wherein:
the content engine associates a link to a resource of each item in the content.

26. The system of claim 25, wherein:
the user interaction engine presents the link together with the corresponding item in the content to the user.

27. The system of claim 1, wherein:
the content engine customizes the content based on one or more of: the user's prior visits, his/her recent comments and ratings on content related to the same or relevant problems, and his/her response to request for wisdom.

28. The system of claim 1, wherein:
the content engine customizes the content based on an experience path of the user in the PS-Map.

29. A computer-implemented method, comprising:
establishing and maintaining a profile and a psycho-spiritual map (PS-Map) of a user, wherein each node in the PS-Map represents one of: a problem submitted by the user, and a set of sub-problems that causes the problem;
enabling the user to submit a problem to which the user intends to seek help or counseling;
presenting the PS-Map to the user;
enabling the user to explore a path through the PS-Map that reflects the potential causes of his/her problem;
identifying, retrieving, customizing, and presenting the content relevant to the problem submitted by the user based on the profile of the user and the path of the user through the PS-Map.

30. The method of claim 29, further comprising:
enabling the user to identify sub-problems as well as to establish connections among the corresponding nodes in the PS-Map by him/herself.

31. The method of claim 29, further comprising:
enabling the user to seek help for identifying sub-problems or connections among the corresponding nodes in the PS-Map.

32. The method of claim 29, further comprising:
enabling the user to provide feedback to the content presented.

33. The method of claim 32, further comprising:
updating the profile based on the problem, content, and feedback from the user.

34. The method of claim 29, further comprising:
associating the content with a corresponding node in the PS-Map.

35. The method of claim 29, further comprising:
initiating one or more questions to the user to solicit information for the purpose of establishing the profile and/or the PS-Map of the user.

36. The method of claim 29, further comprising:
creating new problem nodes and sub-problem nodes and establishing connections among them in the PS-Map.

37. The method of claim 29, further comprising:
changing configuration of the PS-Map dynamically by expanding or shrinking a set of nodes in the PS-Map at an existing node.

38. The method of claim 29, further comprising:
grouping problems from the user that fall within the same category in the same area of the user's PS-Map.

39. The method of claim 29, further comprising:
comparing PS-Map of another user having similar profile or sharing similar problems or concerns as the user in order to construct the PS-Map for the user.

40. The method of claim 29, further comprising:
copying a portion of a PS-Map of another user including nodes, edges, and content items associated with them in order to construct the PS-Map for the user.

41. The method of claim 29, further comprising:
enabling the user to select one of the sub-problem nodes in the PS-Map that most likely causes his/her problem.

42. The method of claim 29, further comprising:
enabling the user to select one of the nodes in the PS-Map that most closely resembles his/her feeling about the cause of problem at the time.

43. The method of claim 29, further comprising:
enabling the user to choose a different cause or a different emotion associated with the same cause when dealing with the same problem he/she has previously encountered.

44. The method of claim 29, further comprising:
maintaining a set of script templates relevant to a set of problems;
identifying a script template in the set of script templates relevant to the problem submitted by the user;
customizing the script template based on the profile and the PS-Map of the user;
retrieving the content based on the script template.

45. The method of claim 29, further comprising:
maintaining a set of script templates relevant to a set of problems;

46. The method of claim 29, further comprising:
maintaining definitions, tags, and source of content relevant to user-submitted problems.

47. The method of claim 29, further comprising:
tagging and organizing the content appropriately for the purpose of easy identification, retrieval, and customization.

48. The method of claim 29, further comprising:
associates a source or a link to a resource of each item in the content;
presenting the source and the link together with the corresponding item in the content to the user.

49. The method of claim 29, further comprising:
customizing the content based on one or more of: the user's prior visits, his/her recent comments and ratings on content related to the same or relevant problems, and his/her response to request for wisdom.

50. The method of claim 29, further comprising:
customizing the content based on an experience path of the user in the PS-Map.

51. A system, comprising:
means for establishing and maintaining a profile and a psycho-spiritual map (PS-Map) of a user, wherein each node in the PS-Map represents one of: a problem submitted by the user, a set of sub-problems that causes the problem, and a set of emotions of the user associated with each of the sub-problems;
means for enabling the user to submit a problem to which the user intends to seek help or counseling;
means for presenting the PS-Map to the user;
means for enabling the user to explore a path through the PS-Map that reflects the potential causes of his/her problem as well as his/her emotions associated with the causes at the time;
means for identifying, retrieving, customizing, and presenting the content relevant to the problem submitted by the user based on the profile of the user and the path of the user through the PS-Map.

52. A machine readable medium having software instructions stored thereon that when executed cause a system to:
establish and maintain a profile and a psycho-spiritual map (PS-Map) of a user, wherein each node in the PS-Map represents one of: a problem submitted by the user, a set of sub-problems that causes the problem, and a set of emotions of the user associated with each of the sub-problems;
enable the user to submit a problem to which the user intends to seek help or counseling;
present the PS-Map to the user;
enable the user to explore a path through the PS-Map that reflects the potential causes of his/her problem as well as his/her emotions associated with the causes at the time;
identify, retrieve, customize, and present the content relevant to the problem submitted by the user based on the profile of the user and the path of the user through the PS-Map.
